(19) United States
(12) Patent Application Publication
(10) Pub. No.: US 2009/0300254 A1
(43) Pub. Date: Dec. 3, 2009

(54) Method for Connecting a Flexray user having a Microcontroller to a Flexray Communications line Via a Flexray Communications Control Device, and Flexray Communications Control Device, Flexray User, and Flexray Communications System for Realizing this Method

(76) Inventors: Josef Newald, Stuttgart (DE); Corina Weber, Ditzingen (DE)

Correspondence Address: KENYON & KENYON LLP, ONE BROADWAY, NEW YORK, NY, 10004, US

(21) Appl. No.: 12/083,274

(22) PCT Filed: Oct. 4, 2006
(86) PCT No.: PCT/EP2006/067042

§ 371 Date: Aug. 5, 2009

(30) Foreign Application Priority Data
Oct. 6, 2005 (DE) 10 2005 048 595.2

(51) Int. Cl. G06F 13/14; B60R 16/02; H04L 12/40

(52) U.S. Cl. 710/305

(57) ABSTRACT

A method for connecting a FlexRay user having a microcontroller, which includes at least one serial interface, to a FlexRay communications link via a FlexRay communications control device having at least one serial hardware interface, the connection between the user and the communications control device being implemented via serial interfaces. To make it possible to connect the user to the communications controller via a serial interface without restricting its functionality, it is provided that at least one serial interface is emulated in the user, or that at least one additional serial interface is developed in the FlexRay communications control device.

### FIELD OF THE INVENTION

The present invention relates to a method for connecting a FlexRay user having a microcontroller.

### BACKGROUND INFORMATION

The networking of control units, sensor systems and actuator systems with the aid of a communications system and a communications connection developed as a bus system has increased drastically in recent years in the manufacture of modern motor vehicles and also in machine construction, especially in the field of machine tools and in the field of automation. In this context, synergistic effects may be achieved by the distribution of functions to a plurality of control units. These are called distributed systems. The communication between various users is increasingly taking place via a communications system designed as a bus system. The communication traffic on the bus system, access and receiving mechanisms, as well as the handling of faults are regulated by a protocol.

One known protocol is, for instance, the FlexRay protocol, which is currently being based on the FlexRay protocol specification v2.0 or v2.1. The FlexRay protocol defines a fast, deterministic and fault-tolerant bus system, particularly for use in a motor vehicle. Data transmission according to the FlexRay protocol takes place according to a time division multiple access (TDMA) method. The data transmission via the communications connection takes place at regularly repeating transmission cycles, each of which is subdivided into a plurality of data frames, which are also referred to as time slots. Fixed time slots are assigned to the users and to the messages to be transmitted, in which they have exclusive access to the communications connection. The time slots repeat in the fixed transmission cycles, so that the instant at which a message is transmitted via the bus can be predicted exactly, and the bus access takes place deterministically.

In order to use the bandwidth for the message transmission on the bus system in optimal fashion, FlexRay subdivides the transmission cycle, which may also be referred to as cycle or bus cycle, into a static and a dynamic part. The fixed time slots are in the static portion at the beginning of a bus cycle. In the dynamic part, the time slots are assigned dynamically. In that dynamic part, the individual exclusive bus access is enabled for a short time only, for one or more so-called minislots. The time slot is lengthened by the necessary time only if a bus access takes place within a minislot. Consequently, bandwidth is used up only if it is also actually needed.

FlexRay communicates via two physically separate lines of the communications connection at a data rate of maximally 10 Mbit/s (10 MBaud), respectively. Every 5 ms, in some communications systems even every 1 ms or 2.5 ms, a bus cycle is concluded. The two channels correspond to the physical layer, in particular of the OSI (open system architecture) layer model. The two channels are used chiefly for the redundant and therefore fault-tolerant transmission of messages, but can also transmit different messages, whereby the data rate would then double. However, FlexRay can also be operated at lower data rates.

In order to implement synchronous functions and to optimize the bandwidth by small spacings between two messages, the users or the distributed components in the communications network thus need a shared time base, the global time as it is commonly known. For the clock synchronization, synchronization messages are transmitted in the static portion of the cycle, the local clock time of a user being corrected with the aid of a special algorithm according to the FlexRay specification in such a way that all local clocks run synchronously with one global clock.

A FlexRay user, also denotable as a FlexRay network node or host, includes a user processor or host processor, a FlexRay controller or communications controller, as well as what is generally known as bus guardian, in the case of bus monitoring. The communications controller is also referred to as communications controller (CC) or communications control device. The user is connected to the communications connection via the communications controller. The user processor supplies and processes the data that are transmitted via the FlexRay communications controller and the FlexRay communications connection. Messages or message objects may be configured at, for instance, up to 254 data bytes for the communication in a FlexRay network.

In order to couple a FlexRay communications connection, via which messages are transmitted, with a FlexRay user, a FlexRay communications module is used in DE 10 2005 034 744, which had not yet been published at the application date of the present invention, which is connected to the user via a user interface (known as customer CPU interface (CIF)), and to the communications connection via another connection (known as generic CPU interface (GIF)). The communication module may be realized as part of the communications controller or as a separate module. For the transmission of the messages between the user and the communications connection, a system for storing the messages is provided in the communications module. The transmission is controlled by a state machine. The memory system includes a message memory, which may be configured as single-ported RAM (random access memory). This RAM memory stores the messages or message objects, that is, the actual useful data, together with configuration data and status data. The exact structure of the message memory of the known communications module can be gathered from the cited printed publication DE 10 2005 034 744. Express reference is made to this printed publication as far as the configuration and function of the communications module are concerned.

An interface module made up of two parts is provided in the communications module, one submodule being user-independent, and the other submodule being user- or customer-specific. The customer-specific submodule, which is also referred to as customer CPU interface (CIF), connects a customer-specific user in the form of a user-specific host CPU to the FlexRay communications module. The user-independent submodule, which is also designated as generic CPU interface (GIF), represents a generic, that is, a general CPU interface, via which it is possible to connect different customer-specific host CPUs to the FlexRay communications module using appropriate customer-specific submodules, that is, customer CPU interfaces (CIFs). This allows an uncomplicated adaptation of the communications module to different users, since only the customer-specific submodule has to be modified as a function of the user or customer, while the user-independent submodule and the remaining communications module may always be developed in the same way. As a consequence, with the aid of the communications module, there results a standard interface for connecting random FlexRay users to a FlexRay communications connection; the interface is flexibly adjustable to users developed in any manner or of any nature by simple modification of the customer-specific submodule. It is also possible to realize the submodules within the one interface module in software in each case, that is, each submodule is implementable as software function, or in hardware.

The state machine in the FlexRay communications module may be hardwired in hardware. The sequences may likewise be hardwired in hardware. Alternatively, the state machine in the communications module may also be freely programmable by the user via the user interface.

The data may include the access type and/or the access manner and/or the access address and/or the data volume and/or control data in connection with the data and/or at least one datum for data protection.

According to the related art, the microcontroller of a FlexRay user has one or a plurality—typically two—serial interfaces, which may be configured as universal synchronous/asynchronous receiver/transmitter (USART) interfaces. Using these interfaces, the microcontroller is connected to one or a plurality of other microcontroller(s) such as of another user, to realize specific functionalities. For example, it is conceivable that the microcontroller of the FlexRay user is connected via a first serial interface to a first serial interface of another microcontroller to realize the functionality of a vehicle immobilizer, and that the microcontroller of the FlexRay user is connected to a second serial interface of another microcontroller or the other microcontroller via a second serial interface to realize the functionality of a LIN (local interconnect network) bus. However, if a connection of the FlexRay user to the FlexRay communications connection is then to occur via the FlexRay communications control device, a serial (such as USART) interface of the microcontroller of the user is being fully utilized and is no longer available for the other functionalities. This results in a considerable restriction of the functionality of the user's microcontroller.

### SUMMARY OF THE INVENTION

The exemplary embodiments and/or exemplary methods of the present invention is based on the objective of configuring and further developing a FlexRay communications system, in particular the microcontroller of a FlexRay user and/or a FlexRay communications controller assigned to the user, in such a way that the user is able to be connected to the communications controller via a serial interface without restricting its functionality.

To achieve this objective, proceeding from the method of the type mentioned in the introduction, it is provided to emulate at least one serial software interface in the FlexRay user and/or to provide at least one additional serial interface in the FlexRay communications control device.

In particular, the present invention relates to a method for connecting a FlexRay user having a microcontroller, which includes at least one serial (such as universal synchronous/asynchronous receiver/transmitter; USART) interface, to a FlexRay communications line via a FlexRay communications control device (so-called FlexRay communications controller (CC)). The FlexRay communication control device has at least one serial (such as USART) interface. The connection between the user and the communication control device is implemented via serial (such as USART) interfaces.

Furthermore, the present invention relates to a FlexRay communications control device (a so-called FlexRay communications controller (CC)) for connecting a FlexRay user having a microcontroller, which has at least one serial (such as USART) interface, to a FlexRay communications connection. The FlexRay communications control device has at least one serial (such as USART) interface. The connection between the user and the communications control device is implemented via serial (such as USART) interfaces.

In addition, the present invention relates to a FlexRay user having a microcontroller, which has at least one serial (such as USART) interface, the user being connectable to a FlexRay communications connection via one of the serial interfaces via a FlexRay communications control device (a so-called FlexRay communications controller (CC)). The connection between the user and the communications control device is implemented via serial (such as USART) interfaces.

Finally, the present invention also relates to a FlexRay communications system, which includes a FlexRay communications connection with FlexRay users connected thereto via FlexRay communications control devices (so-called FlexRay communications controller (CC)). At least one of the users has a microcontroller, which has at least one serial (such as USART) interface. The connection between the at least one user and the communications control device is implemented via serial (such as USART) interfaces.

According to the exemplary embodiments and/or exemplary methods of the present invention, the FlexRay user and/or the FlexRay communications controller are expanded by an additional serial interface designed in the form of hardware or software. Via these additional interface(s), the user is able to be connected to the communications controller, and it is simultaneously possible to maintain all current functionalities of the user. The idea on which the present invention is based is to provide at least one additional serial interface at the microcontroller of the FlexRay user and/or at the FlexRay communications controller, so that the user and the communications controller are able to be interconnected via serial interfaces, and that, at the same time, enough serial interfaces still remain available in the microcontroller of the user in order to be able to realize one or a plurality of additional functionalities (such as vehicle immobilizer and LIN bus) in addition to the FlexRay functionality.

According to one advantageous further development of the exemplary embodiments and/or exemplary methods of the present invention, it is provided to emulate the at least one serial interface on the port expansion pins provided by the communications control device as it is. The port expansion pins are an expansion, or a so-called port, for connecting an external component. The port expansion pins allow only a relatively slow data transmission rate; the achievable bit rates may be sufficient for specific functionalities. According to this further development, the FlexRay communications control device must therefore not be expanded in terms of hardware. The available hardware is utilized to emulate a serial interface thereon.

In order to enable a serial data transmission via the interface emulated on the port expansion pins, one specific embodiment of the present invention provides to assign to the port expansion pins provided by the communications control device as it is, at least one shift register in which the data to be transmitted are buffer-stored for a serial data transmission. Thus, the port expansion pins which are already provided in many FlexRay communications control devices may be augmented by a simple and cost-effective shift register to form a full-fledged serial interface. Using the shift register, the data rate achievable via the emulated interface is able to be increased considerably. In detail, a frequency divider (Baud rate) and a shift register (such as a 12-bit) are provided for transmission. For receiving, a frequency divider, an 8×12 bit shift register and, optionally, a majority decoder (for data reduction with the aid of an n out of m selection) are provided.

According to an exemplary embodiment of the present invention, it is provided that a first connection between one of the serial interfaces of the user and a first functionally is embodied directly in at least one of the serial interfaces emulated in the user; that, optionally, a second connection between another one of the serial interfaces of the user and a second functionality is directly embodied; and that an additional connection between yet another one of the serial interfaces and a FlexRay functionality of the FlexRay communication control device is embodied directly. In an advantageous manner, the particular connection to the first or second functionality is implemented via one of the emulated serial software interfaces that requires the lower data rate.

According to an alternative embodiment of the present invention, it is proposed that at least in one of the serial interfaces developed in the FlexRay communication control device, a first connection is developed directly between one of the serial interfaces of the user and a first functionality, and that a second connection between another one of the serial interfaces of the user and a second functionality is looped through the FlexRay communications control device. In an advantageous manner, the FlexRay functionality together with the second functionality is transmitted via a portion of the second connection between the user and the communication control device. This specific embodiment is a pure hardware approach in which a genuine hardware interface is implemented in the FlexRay communications controller in addition to the already provided serial interface.

As additional achievement of the objective of the present invention, starting from the FlexRay communications control device of the type mentioned in the introduction, it is provided that at least one additional serial hardware interface is developed in the communications control device, so that the communications control device has at least one serial hardware interface over all.

According to one advantageous further development of the present invention, it is provided that the FlexRay communications control device has a FlexRay communications module for coupling the FlexRay communications connection to the FlexRay user; that the communications module has a system for buffer-storing messages as well as a state machine, which controls the transmission of messages between the communications connection and the user in such a way that the state machine specifies or calls up specifiable sequences regarding data for storing and transmission of the messages.

As additional achievement of the object of the exemplary embodiments and/or exemplary methods of the present invention, starting from the FlexRay user of the type mentioned in the introduction, it is provided that at least one serial software interface is emulated in the user, so that the user has a total of at least two serial interfaces.

Finally, as still another achievement of the object of the exemplary embodiments and/or exemplary methods of the present invention, based on the FlexRay communications system of the type mentioned in the introduction, it is provided that the at least one user is directly connected via one of its serial interfaces to a first functionality, is directly connected via another emulated serial interface to a second functionality, and via still another one of its serial interfaces is directly connected to the FlexRay functionality of the FlexRay communications control device assigned to it, or that the at least one user is directly connected to a first functionality via one of its serial interfaces, and is indirectly connected via another one of its serial interfaces, via the FlexRay communications device assigned to it, to a second functionality.

According to one advantageous further development of the present invention, the FlexRay communications system includes a FlexRay communications module for coupling the FlexRay communications device with at least one of the FlexRay users, the communications module including a system for buffer-storing messages and a state machine, which controls the transmission of messages between the communications connection and the user in such a way that the state machine specifies or calls up specifiable sequences regarding data for storing and transmitting the messages.

Additional features, advantages and exemplary embodiments of the present invention are elucidated in greater detail in the following text with reference to the drawing.

### BRIEF DESCRIPTION OF THE DRAWING

FIG. 1 shows a schematic representation of a communications module and its connection to a communications connection and a communications user or host user of a FlexRay communications system.

FIG. 2 shows a special specific embodiment of the communications module from FIG. 1, as well as its connection in detail.

FIG. 3 shows the structure of a message memory of the communications module in FIG. 2.

FIGS. 4, 5 and 6 show a schematic representation of the architecture and the process of a data access in the direction from the user to the message memory.

FIGS. 7, 8 and 9 show the architecture and the process of a data access in the direction from the message memory to the user.

FIG. 10 show a schematic representation of the structure of a message handler and of finite state machines included therein.

FIG. 11 show a schematic representation of component parts of the communications module of FIGS. 1 and 2, as well as the user and the corresponding data paths controlled by the message handler.

FIG. 12 show the access distribution to the message memory with reference to the data paths in FIG. 11.

FIGS. 13 and 14 show various embodiments for providing a connection between a microcontroller of a FlexRay user and a FlexRay communications control device.

FIG. 15 shows a configuration known from the related art, for a connection between two microcontrollers.

FIG. 16 shows a configuration according to the present invention for a connection between two microcontrollers and a communications control device according to a first specific embodiment.

FIG. 17 shows a configuration according to the present invention for a connection between two microcontrollers and a communications control device according to a second specific embodiment.

FIG. 18 shows a configuration according to the present invention for a connection between two microcontrollers and a communications control device according to a third specific embodiment.

### DETAILED DESCRIPTION

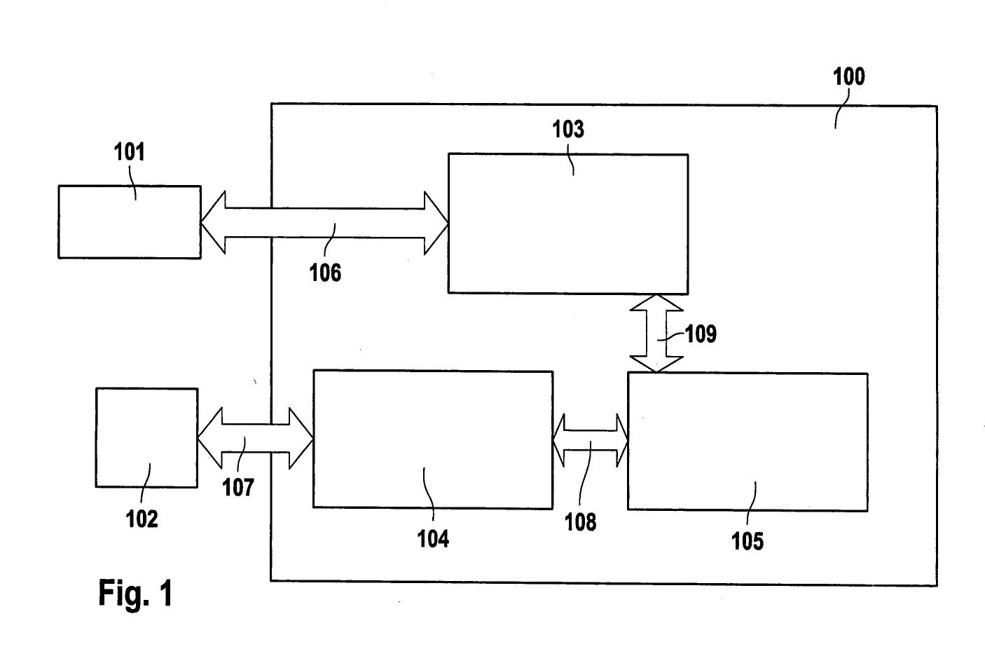

FIG. 1 schematically shows a FlexRay communications module 100 for connecting a user or host 102 to a FlexRay communications link 101, that is, the physical layer of the FlexRay. To that end, FlexRay communications module 100 is connected via a connection 107 to the user or user processor 102, and via a connection 106 to communications link 101. For the problem-free connection first of all with respect to transmission times, and secondly with respect to data integrity, essentially three configurations are schematically differentiated in the FlexRay communications module. In this context, a first configuration 105 is used for storage, in particular as a buffer storage, of at least a portion of the messages to be transmitted. Between user 102 and this first configuration 105, a second configuration 104 is connected via connections 107 and 108.

In the same way, a third configuration 103 is connected via connections 106 and 109 between communication link 101 and first configuration 105, which allows the realization of a very flexible input and output of data as part of messages, particularly FlexRay messages into and out of first configuration 105 at optimal speed, while ensuring the data integrity.

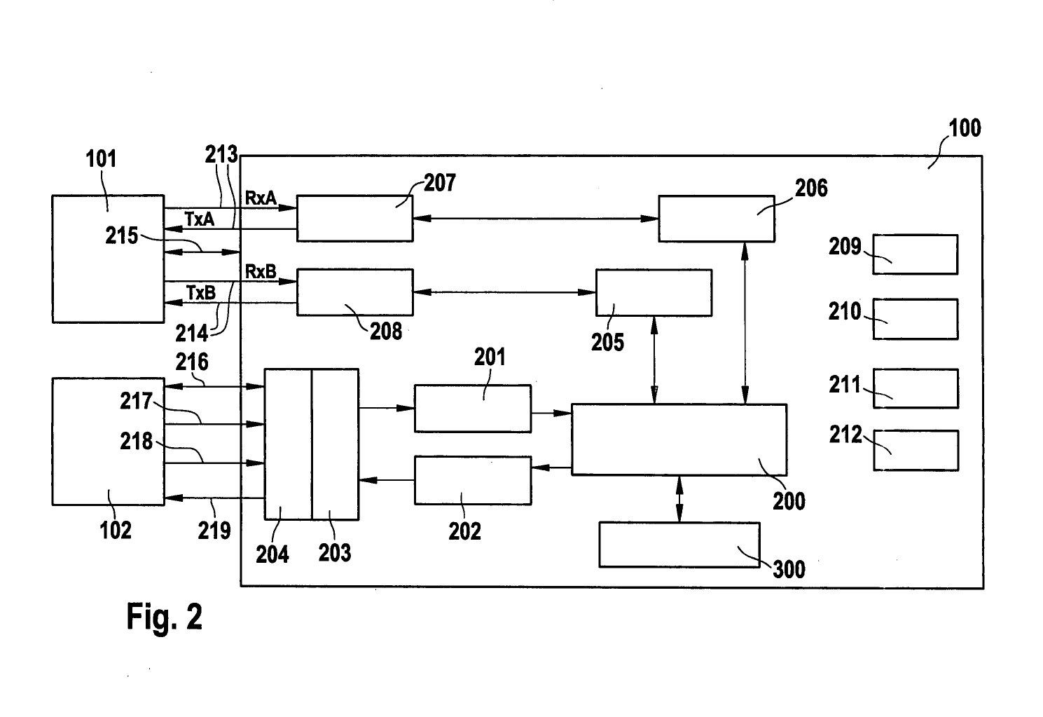

In FIG. 2, this communications module 100 is shown again in greater detail in an exemplary embodiment. Also shown in greater detail are individual connections 106 through 109. To connect FlexRay communication module 100 to FlexRay user 102 or the host processor, second configuration 104 includes an input buffer or input buffer 201 (IBF), an output buffer or output buffer 202 (OBF), as well as an interface module made up of two parts 203 and 204, one submodule 203 being user-independent, and second submodule 204 being user-specific. User-specific sub-module 204 (customer CPU interface CIF) connects a user-specific host CPU 102, that is, a customer-specific user, to the FlexRay communications module. To that end, a bidirectional data line 216, an address line 217 and a control input 218 are typically provided. An interrupt output denoted by 219 is likewise provided.

Also conceivable are the following alternatives for the signals of the serial data connection between users 102 and customer-specific interface 204:

Alternative 1: bidirectional data line 216, timing circuit 217, interrupt line 219;
Alternative 2: bidirectional data line 216, timing circuit 217, control input 218, interrupt line 219;
Alternative 3: serial input line 216, timing circuit 217, serial output line 218, interrupt line 219;
Alternative 4: serial input line 216, timing circuit 217, serial output line 218, interrupt line 219, as well as a control line in addition (not shown).

User-specific submodule 204 is connected to a user-independent submodule 203 (generic CPU interface, GIF); that is, the FlexRay communications module or the FlexRay IP module has a generic, i.e., a general CPU interface 203, to which a large number of different customer-specific host CPUs 102 can be connected via corresponding user-specific submodules 204, i.e., customer CPU interfaces CIF. In this manner, only submodule 204 must be varied as a function of user 102, which means a markedly lower expenditure. CPU interface 203 and remaining communications module 100 are able to be taken over in unchanged form.

Input buffer 201 and output buffer 202 may be formed in one common memory module or else in separate memory modules. Input buffer 201 is used for buffer-storing messages for transmission to message memory 300. Input buffer module 201, in this instance, may be designed in such a way that it is able to store two complete messages, each made up of a header segment, in particular having configuration data, and a data segment or payload segment. Input buffer 201 is in two parts (partial buffer and shadow memory), which means that a transmission between user CPU 102 and message memory 300 may be accelerated by writing the two parts of input buffer 201 by turns, or, by alternating access.

In the same way, output buffer (OBF) 202 is used for the buffer storage of messages for transmission from message memory 300 to user CPU 102. Output buffer 202 is likewise configured in such a way that two complete messages made up of a header segment, particularly having configuration data, and a data segment, i.e., payload segment, are able to be stored. Here, as well, output buffer 202 is subdivided into two parts, a partial buffer and a shadow memory, which means transmission between user or host CPU 102 and message memory 300 may also be accelerated here by reading the two parts by turns, or, by alternating access. This second configuration 104, made up of blocks 201 through 204, is connected to first configuration 105, as shown.

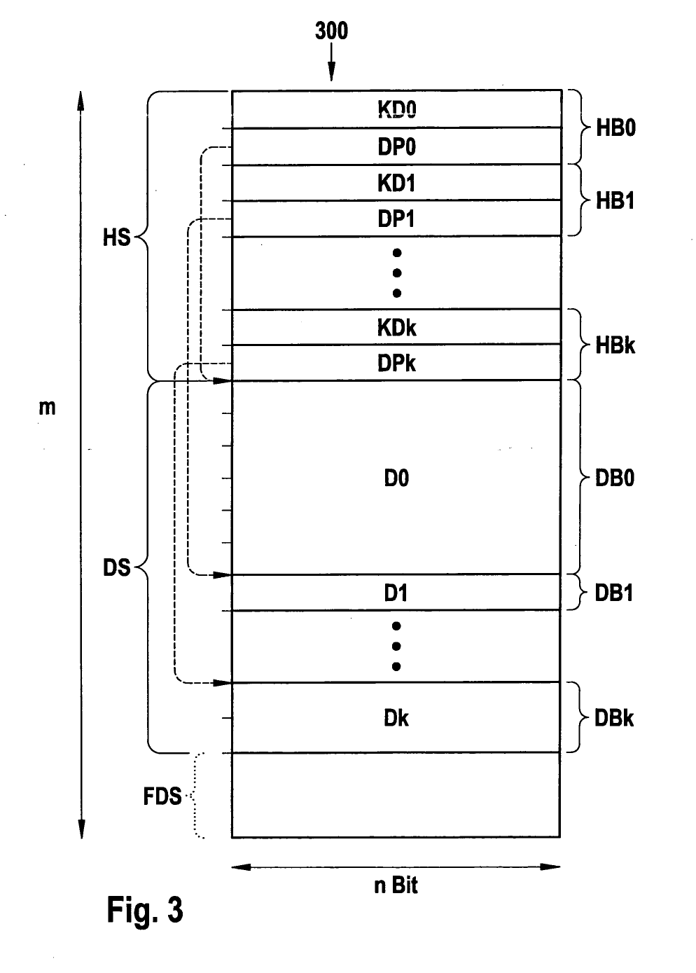

Configuration 105 is made up of a message handler (MHD) 200 and a message memory 300 (message RAM). Message handler 200 checks or controls the data transfer between input buffer 201 as well as output buffer 202, and message memory 300. In like manner, it checks or controls the data transmission in the other direction via third configuration 103. Message memory 300 may be implemented as a single-ported RAM. This RAM memory stores the messages or message objects, that is, the actual data, together with configuration data and status data. The exact structure of message memory 300 is shown in greater detail in FIG. 3.

Third configuration 103 is made up of blocks 205 through 208. Corresponding to the two channels of the FlexRay physical layer, this configuration 103 is subdivided into two data paths, each having two data directions. This becomes clear through connections 213 and 214, wherein the two data directions are shown for channel A by RxA and TxA for receiving (RxA) and for transmitting (TxA), as well as for channel B, by RxB and TxB. An optional bidirectional control input is denoted by connection 215. Third configuration 103 is connected via a first buffer 205 for channel B and a second buffer 206 for channel A. These two buffers (transient buffer RAMS: RAM A and RAM B) are used as buffer storage for the data transmission from or to first configuration 105. Corresponding to the two channels, these two buffers 205 and 206 are connected to an interface module 207 and 208, respectively, which contain the FlexRay protocol controllers or bus protocol controllers made up of a transmit/receive shift register and the FlexRay protocol finite state machine. Therefore, the two buffers 205 and 206 are used as buffer stores for the data transmission between the shift registers of the interface modules or FlexRay protocol controllers 207 and 208 and message memory 300. The data fields, that is, the payload segment or data segment of two FlexRay messages are advantageously stored by each buffer 205 or 206 here, as well.

Also shown in communications module 100 is the global time unit (GTU), designated by 209, which is responsible for representing the global time-slot pattern in the FlexRay, that is, the micro tick μT and the macro tick MT. The fault-tolerant clock synchronization of the cycle counters and the control of the time sequences in the static and dynamic segment of the FlexRay are regulated via global time unit 209, as well. Block 210 represents the general system control (system universal control SUC) by which the operating modes of FlexRay communications controller 750 are checked and controlled. They include the wake-up, the startup, the reintegration or integration, normal operation and passive operation.

Block 211 shows the network and error management NEM as described in the FlexRay protocol specification v2.0 or v2.1. Finally, block 212 shows the interrupt control (INT) which manages the status and error interrupt flags and checks or controls interrupt outputs 219 to user CPU 102. In addition, block 212 contains an absolute and a relative timer for generating the time interrupts or timer interrupts.

Message objects or messages (message buffer) may be configured with up to 254 data bytes for the communication in a FlexRay network. In particular, message memory 300 is a message RAM which, for example, is able to store up to a maximum of 64 or more (e.g., 128) message objects. All functions which relate to the handling or management of the messages themselves are implemented in message handler 200. They are, for example, the acceptance filtering, transfer of messages between the two FlexRay protocol controller blocks 207 and 208 and message memory 300, that is, the message RAM, as well as the control of the transmit sequence and the provision of configuration data and status data, respectively.

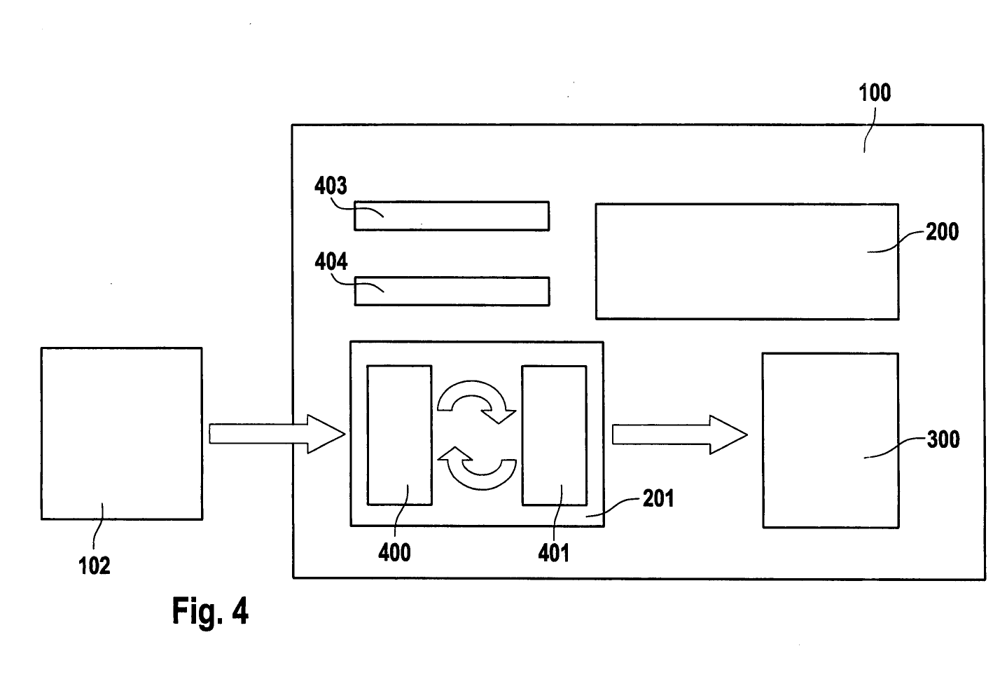

An external CPU, that is, an external processor, user processor 102, is able to directly access the registers of FlexRay communications module 100 via user interface 107 having user-specific part 204. A multitude of registers is used in this context. These registers are used to configure and control the FlexRay protocol controllers, that is, interface modules 207 and 208, message handler (MHD) 200, global time unit (GTU) 209, system universal controller (SUC) 210, network and error management unit (NEM) 211, interrupt controller (INT) 212, as well as the access to the message RAM, that is, message memory 300, and are used to indicate the corresponding status, as well. At least parts of these registers will still be discussed in greater detail in FIGS. 4 through 6 and 7 through 9. Such a described FlexRay communications module 100 permits easy implementation of FlexRay specification v2.0, thereby making it possible to generate an ASIC or a microcontroller having corresponding FlexRay functionality in an uncomplicated manner.

Because of described FlexRay communications module 100, the FlexRay protocol specification, especially v2.0, can be fully supported and, with that, for instance up to 64 or more (e.g., 128) messages or message objects are able to be configured. This yields a flexibly configurable message memory for storing a different number of message objects as a function of the size of the respective data field or data area of the message. In an advantageous manner, it is therefore possible to configure messages or message objects that have data fields of different lengths. Message memory 300 is advantageously developed as FIFO (first in, first out) in this instance, so that a configurable receive FIFO results. Each message and each message object in the memory may be configured as a receive buffer object (receive buffer), transmit buffer object (transmit buffer), or as a part of the configurable receive FIFO. Acceptance filtering for frame ID, channel ID and cycle counter is also possible in the FlexRay network. The network management is consequently supported in an expedient manner. In addition, maskable module interrupts are advantageously provided.

FIG. 3 shows the partitioning of message memory 300 in detail. For the functionality of a FlexRay communications controller 750 required according to the FlexRay protocol specification, a message memory is needed for making available messages to be transmitted (transmit buffer Tx), as well as for storing messages received without error (receive buffer Rx). A FlexRay protocol allows messages having a data area, that is a payload area, of 0 to 254 bytes. As FIG. 2 shows, message memory 300 is part of FlexRay communication module 100. The method described in the following, as well as corresponding message memory 300, illustrate the storing of messages to be transmitted and of received messages, particularly using a random access memory (RAM), the mechanism described making it possible to store a variable number of messages in a message memory of specified size. The number of messages able to be stored is a function of the size of the data areas of the individual messages, which means first of all, it is possible to minimize the size of the memory needed without limiting the size of the data areas of the messages, and secondly, the memory is optimally utilized. This variable partitioning of, in particular, a RAM-based message memory 300 for a FlexRay communications controller shall now be described in greater detail below.

For the implementation, a message memory having a stipulated word length of n bits, e.g., 8, 16, 32, etc., as well as a predefined memory depth of m words (m, n as natural numbers) is now specified by way of example. In this instance, message memory 300 is partitioned into two segments, a header segment HS and a data segment DS (payload section, payload segment). Thus, one header area HB and one data area DB are created per message. Therefore, for messages 0, 1 through k (k as natural number), header areas HB0, HB1 through HBk, and data areas DB0, DB1 through DBk are created. Thus, first and second data are differentiated in a message, the first data corresponding to configuration data and/or status data with respect to the FlexRay message, and in each case being stored in a header area HB (HB0, HB1, . . . , HBk). The second data, which correspond to the actual payload data to be transmitted, are stored accordingly in data areas DB (DB0, DB1, . . . , DBk). Thus, a first scope of data (measured in bits, bytes or memory words) is created for the first data per message, and a second scope of data (likewise measured in bits, bytes or memory words) is created for the second data of a message; the second scope of data is able to be different per message. The partition between header segment HS and data segment DS is now variable in message memory 300, i.e., no predefined boundary exists between the areas. The partition between header segment HS and data segment DS is a function of the number k of messages, as well as of the second scope of data, that is, the scope of the actual payload data, of one message or of all k messages together. A pointer element or data pointer DP0, DP1 through DPk is now in each case assigned directly to configuration data KD0, KD1 through KDk of the respective message. In the special embodiment, a fixed number of memory words, in this case, two, is assigned to each header area HB0, HB1 through HBk, so that one configuration datum KD (KD0, KD1, . . . , KDk) and one pointer element DP (DP0, DP1, . . . , DPk) are always filed together in one header area HB. Following this header segment HS having header areas HB, whose size or first scope of data is a function of the number k of messages to be stored, is data segment DS for storing actual message data D0, D1 through Dk. This data segment (or data section) DS is dependent in its scope of data on the respective scope of data of the message data stored, here, for example, six words in DB0, one word in DB1 and two words in DBk. Therefore, respective pointer elements DP0, DP1 through DPk always point to the beginning, that is, to the start address of the respective data area DB0, DB1 through DBk in which data D0, D1 through Dk of respective messages 0, 1 through k are stored. Consequently, the partitioning of message memory 300 between header segment HS and data segment DS is variable and is a function of the number k of messages themselves as well as the specific scope of data of one message, and therefore the entire second scope of data. If fewer messages are configured, header segment HS becomes smaller and the area becoming free in message memory 300 may be used as supplement to data segment DS for the storage of data. This variability ensures optimal memory utilization, thereby also permitting the use of smaller memories. Free data segment FDS, particularly its size, is likewise a function of the combination of the number k of stored messages and the specific second scope of data of the messages, is therefore minimal and may even become 0.

In addition to the use of pointer elements, it is also possible to store the first and second data, that is, the configuration data KD (KD0, KD1, . . . , KDk) and actual data D (D0, D1, . . . , Dk), in a specifiable sequence, so that the sequence of header areas HB0 through HBk in header segment HS and the sequence of data areas DB0 through DBk in data segment DS are identical in each case. It could then even be possible, under certain circumstances, to dispense with a pointer element.

In one special development, the message memory is assigned an error-identifier generator, particularly a parity bit generator element, and an error-identifier checker, particularly a parity bit check element, to ensure the correctness of the stored data in HS and DS, in that one checksum may be co-stored, especially as a parity bit, per memory word or per area (HB and/or DB). Other check identifiers, e.g., a CRC (cyclic redundancy check) or even identifiers of greater power such as ECC (error code correction) are conceivable. Consequently, the following advantages result compared to a fixed partitioning of the message memory:

In programming, the user is able to decide whether he would like to use a larger number of messages having a small data field or a smaller number of messages having a large data field. In the configuration of messages having a data area DB of variable size, the available memory space is optimally utilized. The user has the possibility of utilizing one data-memory area jointly for different messages.

In the implementation of the communications controller on an integrated circuit, it is possible to adjust the size of message memory 300 by adapting the memory depth (the number m of words) of the memory used, to the requirements of the application, without altering the other functions of the communications controller.

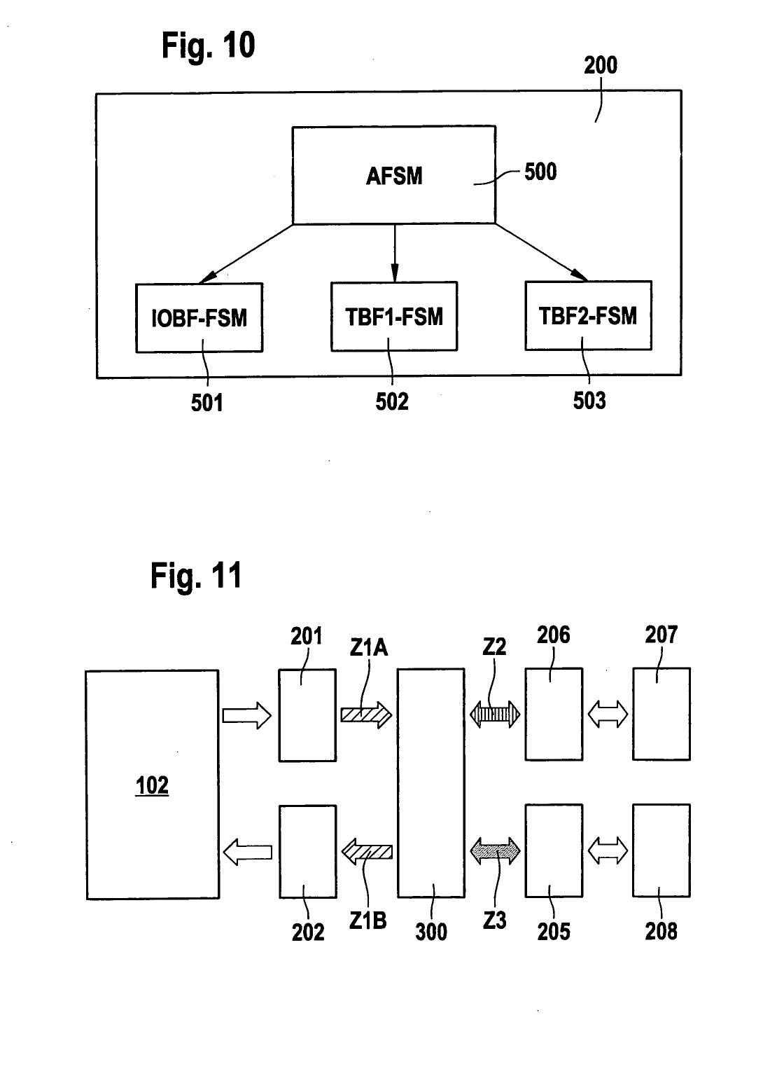

In the following, the host CPU access, thus writing and reading of configuration data and status data, respectively, and the actual data via buffer configuration 201 and 202, is now described in greater detail with reference to FIGS. 4 through 6 and 7 through 9. In so doing, the goal is to produce a decoupling with respect to the data transmission, such that the data integrity may be ensured, and at the same time a high transmission rate is guaranteed. These operations are controlled via message handler 200, which will be described later in greater detail in FIGS. 10, 11 and 12.

The write accesses to message memory 300 by the host CPU of user CPUs 102, via input buffer 201 is first explained in greater detail in FIGS. 4, 5 and 6. For that purpose, FIG. 4 again shows communications module 100, but only the parts of communication module 100 relevant here are shown for reasons of clarity. They are, first of all, message handler 200 responsible for controlling the operational sequences, as well as two control registers 403 and 404 which, as shown, may be accommodated outside of message handler 200 in communications module 100, but may also be contained in message handler 200 itself. 403 represents the input buffer command request register, and 404 represents the input buffer command mask register. Thus, write accesses by host CPUs 102 to message memory 300 (message RAM) take place via an interposed input buffer 201. This input buffer 201 is now designed in a divided or duplicated manner, and specifically as partial buffer 400 and a shadow memory 401 belonging to the partial buffer. Consequently, as described below, a continuous access of host CPUs 102 to the messages or message objects, or rather data of message memory 300 is able to be accomplished, and with that, data integrity and accelerated transmission are ensured.

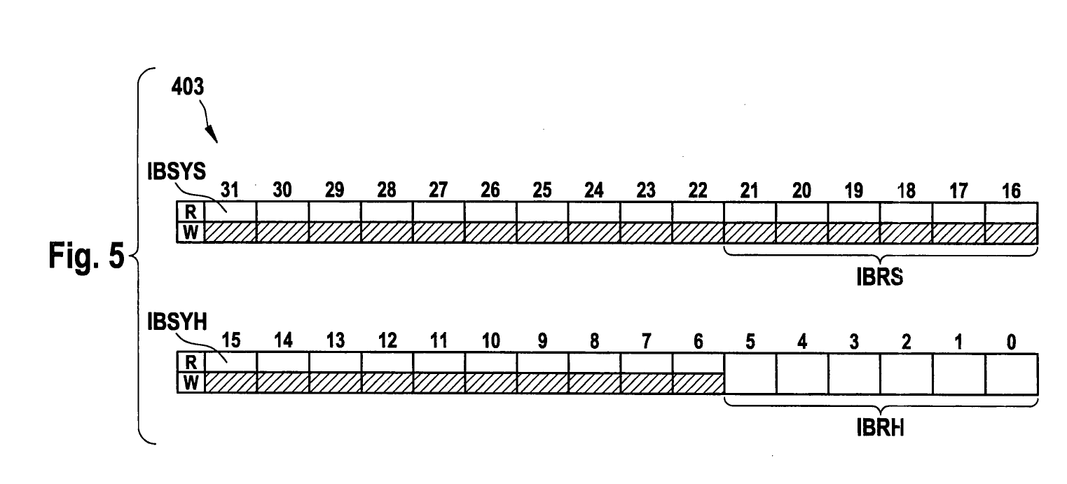

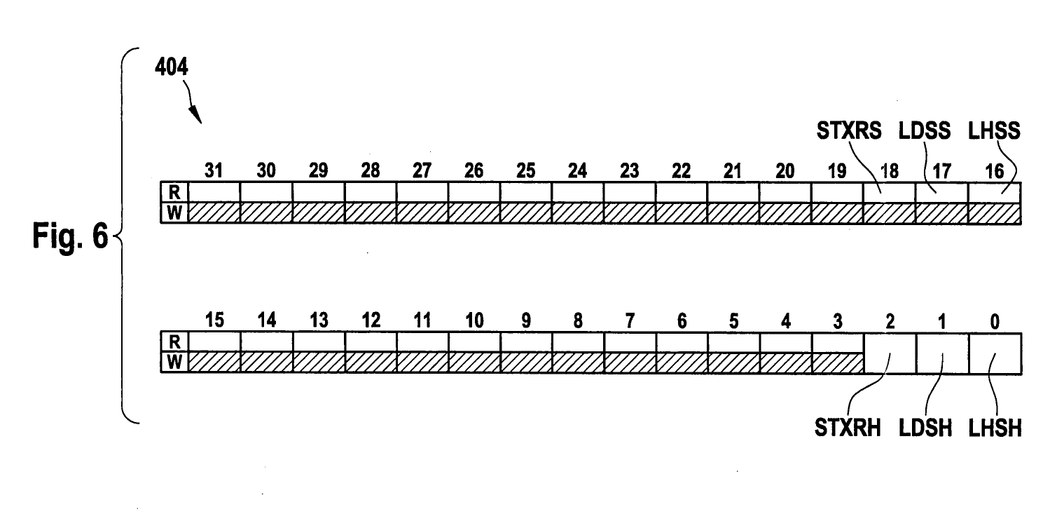

The accesses are controlled via input buffer command request register 403, and via input buffer command mask register 404. In register 403, the numbers from 0 through 31 represent the respective bit positions in 403 in FIG. 5, here, by way of example, for a width of 32 bits. The same holds true for register 404, and bit positions 0 through 31 in masking register 404 of FIG. 6.

As example, bit positions 0 through 5, 15, 16 through 21 and 31 of register 403 are now given a special function with respect to the sequence control. Thus, an identifier IBRH (input buffer request host) is able to be entered as message identifier into bit positions 0 through 5 of register 403. In the same way, an identifier IBRS (input buffer request shadow) is able to be entered into bit positions 16 through 21 of register 403. IBSYH is entered into register position 15 of 403, and IBSYS is entered into register position 31 of 403 as access identifiers, as well. Positions 0 through 2 of register 404 are also marked, further identifiers being entered as data identifiers in 0 and 1 with LHSH (load header section host) and LDSH (load data section host). These data identifiers are in the simplest form here, namely, each takes the form of one bit. In bit position 2 of register 404, a start identifier is written in with STXRH (set transmission X request host). In the following, the sequence of the write access to message memory 300 via input buffer 201 is now described.

Host CPU 102 writes the data of the message to be transferred into input buffer 201. In so doing, host CPU 102 is able to write only the configuration and header data KD of a message for header segment HS of message memory 300, or only the actual data D of a message that are to be transmitted for data segment DS of message memory 300, or both. Which part of a message, that is, configuration data and/or the actual data, is to be transmitted is established by special data identifiers LHSH and LDSH in input buffer command mask register 404. In this context, LHSH (load header section host) establishes whether the header data, that is, configuration data KD, are to be transmitted, and LDSH (load data section host) establishes whether data D are to be transmitted. Because input buffer 201 is designed in two parts having a partial buffer 400 and an associated shadow memory 401, and a two-way alternate access is intended to take place, two further data-identifier areas, which are now related to shadow memory 401, are provided as counterpart to LHSH and LDSH. These data identifiers in bit positions 16 and 17 of register 404 are denoted by LHSS (load header section shadow) and LDSS (load data section shadow). They therefore control the transmission process with respect to shadow memory 401.

If the start bit or start identifier STXRH (set transmission X request host) is now set in bit position 2 of input buffer command mask register 404, then, after configuration data KD and/or actual data D to be transmitted have been transferred into message memory 300, a transmission request is automatically set for the corresponding message object. That is to say, the automatic transmission of a transmitting message object is controlled, especially started, by this start identifier STXRH.

Correspondingly, the counterpart to this for the shadow memory 401 is start identifier STXRS (set transmission X request shadow) which, for example, is contained in bit position 18 of input buffer command mask register 404, and here in the simplest case is likewise in the form of one bit. The function of STXRS is analogous to the function of STXRH, merely specific to shadow memory 401.

When host CPU 102 writes the message identifier, especially the number of the message object in message memory 300, into which the data of input buffer 201 are to be transferred, into bit positions 0 through 5 of input buffer command request register 403, that is, to IBRH, partial buffer 400 of input buffer 201 and associated shadow memory 401 are exchanged, or the respective access of host CPU 102 and message memory 300 to the two partial memories 400 and 401 is exchanged, as indicated by the semicircular arrows. In so doing, for example, the data transfer, that is, the data transmission to message memory 300 is started, as well. The data transmission to message memory 300 itself is accomplished from shadow memory 401. At the same time, register areas IBRH and IBRS are exchanged. LHSH and LDSH are exchanged for LHSS and LDSS, as well. Likewise, STXRH is exchanged with STXRS. Therefore, IBRS shows the identifier of the message, that is, the number of the message object for which a transmission, i.e., a transfer from shadow memory 401, is in operation, or which message object, i.e., which area in message memory 300, has received data (KD and/or D) from shadow memory 401 most recently. By the identifier (here again, for example, 1 bit) IBSYS (input buffer busy shadow) in bit position 31 of input buffer command request register 403, it is indicated whether a transmission with involvement of shadow memory 401 is taking place at the moment. Thus, for example, in the case of IBSYS=1, transmission is taking place from shadow memory 401 at the moment, and in the case of IBSYS=0, it is not. For example, this bit IBSYS is set by the writing of IBRH, that is, bit positions 0 through 5 in register 403 in order to indicate that a transfer between shadow memory 401 and message memory 300 is in operation. After this data transmission to message memory 300 has ended, IBSYS is reset again.

While the data transfer from shadow memory 401 is just in process, host CPU 102 is able to write the next message to be transferred into input buffer 201 or into partial buffer 400. With the aid of a further access identifier IBSYH (input buffer busy host), e.g., in bit position 15 of register 403, the identifier may be even further refined. If host CPU 102 is just writing IBRH, that is, bit positions 0 through 5 of register 403, while a transmission between shadow memory 401 and message memory 300 is in progress, that is, IBSYS=1, then IBSYH is set in input buffer command request register 403. As soon as the current transfer, that is, the current transmission is concluded, the requested transfer (request through STXRH, see above) is started, and bit IBSYH is reset. Bit IBSYS remains set during the entire time to indicate that data are being transferred to message memory 300. All bits used in all the exemplary embodiments may also be in the form of identifiers having more than one bit. A one-bit solution is advantageous for economic reasons from the standpoint of memory and processing.

The mechanism thus described allows host CPU 102 to continually transfer data into the message objects located in message memory 300 and made up of header area HB and data area DB, assuming the access speed of host CPU 102 to input buffer 201 is less than or equal to the internal data-transfer rate of the FlexRay IP module, that is, of communications module 100.

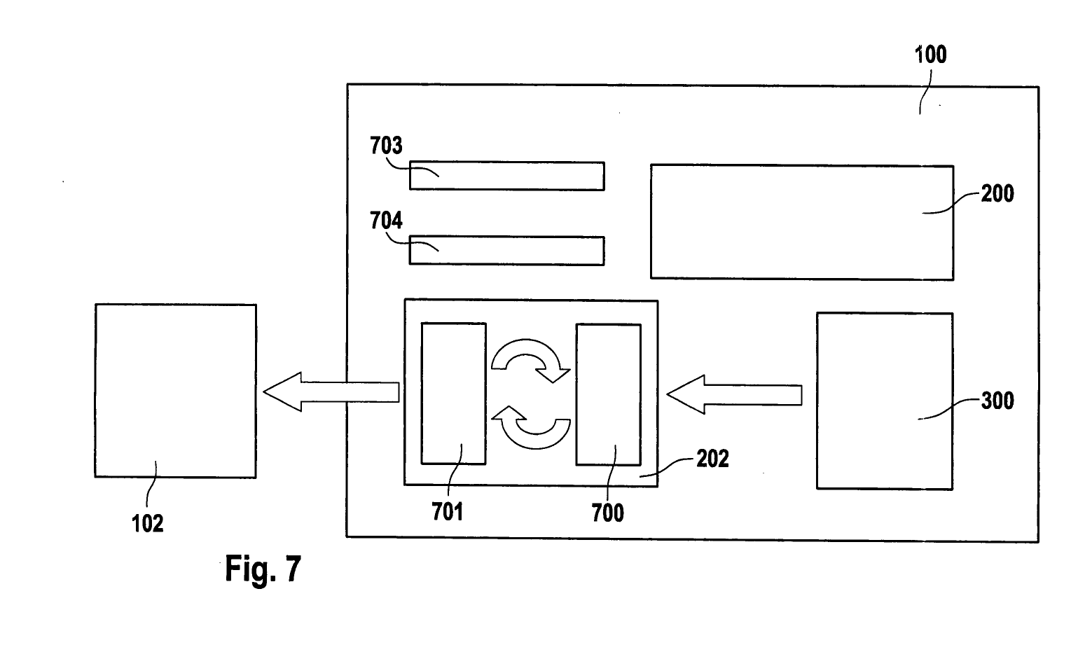

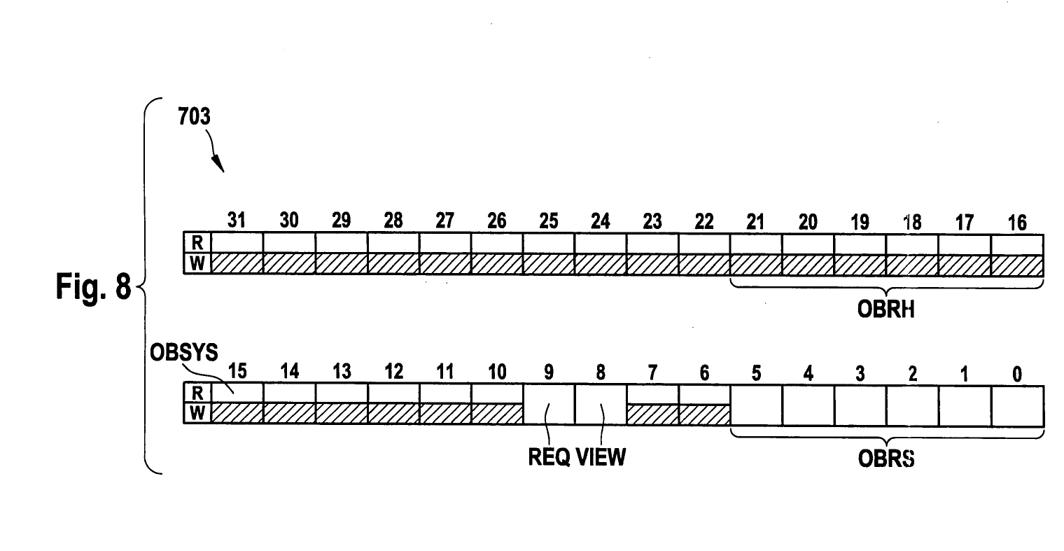

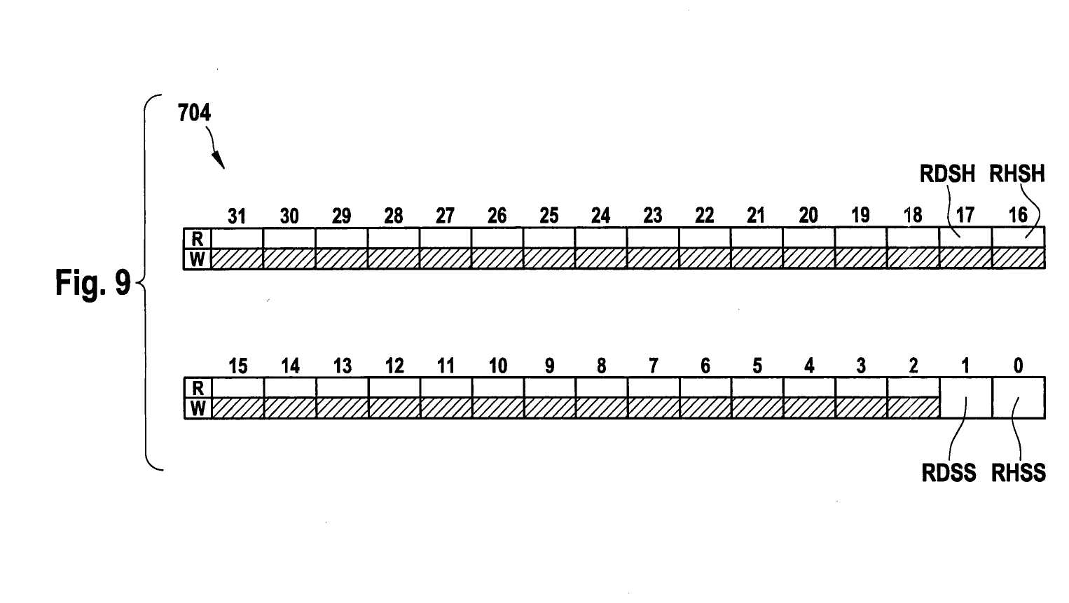

The read accesses to message memory 300 by host CPUs or user CPUs 102 via output buffer 202 are now elucidated in FIGS. 7, 8 and 9. For that purpose, FIG. 7 again shows communications module 100; for reasons of clarity, only the relevant parts of communications module 100 are shown here, as well. They are, first of all, message handler 200 responsible for controlling the operational sequences, as well as two control registers 703 and 704 which, as shown, may be accommodated outside of message handler 200 in communications module 100, but may also be contained in message handler 200 itself. 703 represents the output buffer command request register, and 704 represents the output buffer command mask register. Thus, read accesses by host CPUs 102 to message memory 300 take place via interposed output buffer 202. This output buffer 202 is now likewise designed in a divided or duplicated manner, and specifically as partial buffer 701 and a shadow memory 700 belonging to the partial buffer. Consequently, as described below, a continuous access by host CPUs 102 to the messages or message objects, or rather data of message memory 300 is able to be accomplished here, as well, and with that, data integrity and accelerated transmission are now ensured in the reverse direction from message memory 300 to host 102. The accesses are controlled via output buffer command request register 703, and via output buffer command mask register 704. Also in register 703, the numbers from 0 through 31 represent the respective bit positions in 703, here, by way of example, for a width of 32 bits (cf. FIG. 8). The same holds true for register 704 and bit positions 0 through 31 in 704 (cf. FIG. 9).

As an example, bit positions 0 through 5, 8 and 9, 15 and 16 through 21 of register 703 are now given a special function with respect to the sequence control of the read access. Thus, an identifier OBRS (output buffer request shadow) is able to be entered as message identifier into bit positions 0 through 5 of register 703. In the same way, an identifier OBRH (output buffer request host) is able to be entered into bit positions 16 through 21 of register 703. An identifier OBSYS (output buffer busy shadow) is able to be entered as access identifier into bit position 15 of register 703. Positions 0 and 1 of output buffer command mask register 704 are also marked, further identifiers being entered as data identifiers into bit positions 0 and 1 with RDSS (read data section shadow) and RHSS (read header section shadow). Additional data identifiers are provided, for example, in bit positions 16 and 17 with RDSH (read data section host) and RHSH (read header section host). These data identifiers are also in the simplest form here by way of example, namely, each takes the form of one bit. A start identifier REQ is entered into bit position 9 of register 703. A switchover identifier VIEW is also provided, which is entered by way of example into bit position 8 of register 703.

Host CPU 102 requests the data of a message object from message memory 300 by writing the identifier of the desired message, thus, in particular, the number of the desired message object, to OBRS, that is, into bit positions 0 through of register 703. As in the reverse direction, in this case host CPU 102 may also either read only the status or configuration data and header data KD of a message, that is, from a header area, or may only read data D of a message actually to be transmitted, that is, from the data area, or also both. Thus, which part of the data is to be transmitted from the header area and/or data area is established, in this instance, in a manner comparable to the reverse direction by RHSS and RDSS. That is to say, RHSS indicates whether the header data are to be read, and RDSS indicates whether the actual data are to be read.

A start identifier is used to start the transmission from message memory 300 to shadow memory 700. That is, if, as in the simplest case, one bit is used as identifier, the transmission from message memory 300 to shadow memory 700 is started by setting bit REQ in bit position 9 in output buffer command request register 703. The active transmission is again indicated by an access identifier, here again in the simplest case, by one bit OBSYS in register 703. To avoid collisions, it is advantageous if bit REQ can be set only if OBSYS is not set, thus no active transmission is taking place at the moment. The message transfer between message memory 300 and shadow memory 700 then also takes place here. The actual operational sequence could now, on the one hand, be controlled in a manner comparable to the reverse direction as described under FIGS. 4, 5 and 6 (complementary register occupancy) and carried out, or else, in a variation, be controlled by an additional identifier, namely, a switchover identifier VIEW in bit position 8 of register 703. That is, after the transmission is completed, bit OBSYS is reset, and partial buffer 701 and associated shadow memory 700 are exchanged, i.e., the accesses to them are exchanged, by setting the bit VIEW in output buffer command request register 703, and host CPU 102 is now able to read out the message object requested from message memory 300, that is, the corresponding message, from partial buffer 701.

In this context, comparable to the reverse transmission direction in FIGS. 4 through 6, register cells OBRS and OBRH are exchanged here, as well. RHSS and RDSS are likewise exchanged for RHSH and RDSH. As a protective mechanism, it is also possible in this case to provide that the bit VIEW can be set only if OBSYS is not set, that is, no active transmission is taking place.

Therefore, read accesses by host CPU 102 to message memory 300 take place via an interposed output buffer 202. Just like input buffer 201, this output buffer 202 has a two-part or duplicate design to ensure a continuous access of host CPU 102 to the message objects, which are stored in message memory 300. The advantages of high data integrity and accelerated transmission are achieved here, as well.

The use of input and output buffers 201, 202 described ensures that a host CPU 102 is able to access message memory 300 without interruption in spite of the module-internal latency times.

To guarantee this data integrity, the data transmission, especially the forwarding in communications module 100, is undertaken by message handler (MHD) 200. In this connection, message handler 200 is shown in FIG. 10. Message handler 200 is representable in its functionality by a plurality of state machines or state automatons, that is, finite automatons referred to as finite state machines (FSM). In this instance, at least three finite state machines are provided, and in one special specific embodiment, four finite state machines are provided. A first finite state machine is the IOBF-FSM (input/output buffer state machine), designated by 501. This IOBF-FSM could also be subdivided into two finite state machines, depending on the transmission direction, with respect to the input buffer 201 or the output buffer 202, IBF-FSM (input buffer FSM) and OBF-FSM (output buffer FSM); a maximum of five state automatons (IBF-FSM, OBF-FSM, TBF1-FSM, TBF2-FSM, AFSM) would thereby be conceivable. However, one joint IOBF-FSM may be provided. In accordance with the exemplary embodiment, a second finite state machine is subdivided here into two blocks 502 and 503 and serves the two channels A and B with respect to memories 205 and 206, as described in connection with FIG. 2. In this context, one finite state machine may be provided to serve both channels A and B, or else, as in the described form, one finite state machine TBF1-FSM designated by 502 (transient buffer 1 (206, RAM A) state machine) for channel A, and one TBF2-FSM designated by 503 (transient buffer 2 (205, RAM B) state machine) for channel B.

In the exemplary embodiment, an arbiter finite state machine, referred to as AFSM and denoted by 500, is used to control the access of the three finite state machines 501-503. The data (KD and/or D) are transmitted in a clock pulse, generated by a clock-pulse arrangement such as a VCO (voltage controlled oscillator), a quartz-crystal oscillator, etc., or adapted from it, in the communications module 100. In this context, clock pulse T may be generated in the module or predefined from outside, e.g., as bus timing. This arbiter finite state machine AFSM 500 gives access to message memory 300 by turns to one of the three finite state machines 501-503, particularly in each instance for one clock-pulse period T.

That is, the time available is distributed in accordance with the access requests by individual state automatons 501, 502, 503, to these requesting state automatons. If only one finite state machine requests access, then it receives 100% of the access time, that is, all clock pulses T. If two finite state machines request access, then each finite state machine receives 50% of the access time. Finally, if three state automatons request access, then each of the finite state machines receives ⅓ of the access time. The bandwidth available in each case is thereby optimally utilized.

First finite state machine 501, that is, IOBF-FSM, carries out the following actions as needed:
Data transfer from input buffer 201 to the selected message object in message memory 300.
Data transfer from the selected message object in message memory 300 to output buffer 202.

Finite state machine 502 for channel A, that is, TBF1-FSM, carries out the following actions:
Data transfer from the selected message object in message memory 300 to buffer 206 of channel A.
Data transfer from buffer 206 to the selected message object in message memory 300.
Search for the appropriate message object in message memory 300; upon reception, the message object (receive buffer) is sought for storage of a message, received on channel A, within the framework of an acceptance filtering, and upon sending, the next message object (transmit buffer) to be sent on channel A is sought.

The action of TBF2-FSM, that is, of the finite state machine for channel B in block 503, is analogous thereto. It carries out the data transfer from the selected message object in message memory 300 to buffer 205 of channel B, and the data transfer from buffer 205 to the selected message object in message memory 300. The search function for an appropriate message object in message memory 300 is also analogous to TBF1-FSM; upon reception, the message object (receive buffer) is sought for storage of a message, received on channel B, within the framework of an acceptance filtering, and upon transmission, the next message or message object (transmit buffer) to be transmitted on channel B is sought.

The operational sequences and the transmission paths are now shown once more in FIG. 11. The three finite state machines 501-503 control the respective data transmissions between the individual components. The host CPU is again represented by 102, the input buffer by 201, and the output buffer by 202. The message memory is represented by 300, and the two buffers for channel A and channel B are represented by 206 and 205, respectively. Interface elements 207 and 208 are likewise shown. First state automaton IOBF-FSM, designated by 501, controls data transfer Z1A and Z1B, i.e., from input buffer 201 to message memory 300 and from message memory 300 to output buffer 202. The data are transmitted via data buses having a word length of, e.g., 32 bits, any other bit number also being possible. The same holds true for transmission Z2 between the message memory and buffer 206. This data transmission is controlled by TBF1-FSM, that is, state machine 502 for channel A. Transmission Z3 between message memory 300 and buffer 205 is controlled by state automaton TBF2-FSM, that is, 503. Here, as well, the data are transferred via data buses with a word length of, e.g., 32 bits, any other bit number likewise being possible here. Normally, the transfer of a complete message object via the indicated transmission paths requires a plurality of clock-pulse periods T. Therefore, the transmission time is divided specific to clock-pulse periods T by the arbiter, i.e., AFSM 500. Thus, FIG. 11 shows the data paths between the memory components controlled by message handler 200. To ensure the data integrity of the message objects stored in message memory 300, data should advantageously be exchanged at the same time on only one of the paths shown, i.e., Z1A and Z1B as well as Z2 and Z3.

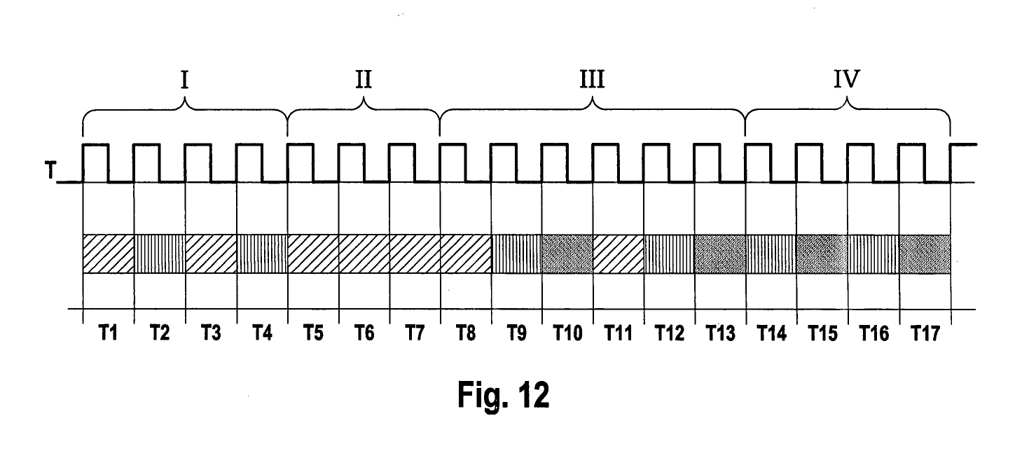

FIG. 12 shows, by way of example, how the available system clock pulses T are distributed by the arbiter, that is, AFSM 500, to the three requesting state automatons. In phase 1 (I), access requests are made by state automaton 501 and state automaton 502, which means that the entire time is distributed one half each to the two requesting state automatons. Specific to the clock-pulse periods in phase 1 (I), this means that finite state machine 501 receives access in clock-pulse periods T1 and T3, and finite state machine 502 receives access in clock-pulse periods T2 and T4. In phase 2 (II), access is made only by state machine 501, so that all three clock-pulse periods, that is 100% of the access time from T5 through T7 is allotted to IOBF-FSM. In phase 3 (III), access requests are made by all three state automatons 501 through 503, so that the total access time is divided into thirds.

For example, arbiter AFSM 500 then distributes the access time so that finite state machine 501 receives access in clock-pulse periods T8 and T11, finite state machine 502 receives access in clock-pulse periods T9 and T12, and finite state machine 503 receives access in clock-pulse periods T10 and T13. Finally, in phase 4 (IV), access is carried out by two state automatons 502 and 503 on the two channels A and B of communications module 100, so that an access distribution of clock-pulse periods T14 and T16 to finite state machine 502 is implemented, and in T15 and T17 to finite state machine 503.

Thus, arbiter finite state automaton AFSM 500 ensures that, for the case when more than one of the three finite state machines 501-503 makes a request for access to message memory 300, the access is distributed with clock-pulse timing and in alternation to requesting finite state machines 501-503. This procedure ensures the integrity of the message objects stored in message memory 300, that is, the data integrity. For example, if host CPU 102 wants to read out a message object via output buffer 202 while at the moment a received message is being written into this message object, then depending upon which request was started first, either the old state or the new state is read out, without the accesses in the message object in message memory 300 themselves colliding.

The method described permits host CPU 102, during continuous operation, to read or to write any message object in message memory 300 without the selected message object being blocked from participation in the data exchange on both channels of the FlexRay bus 101 for the duration of the access by the host CPU (buffer locking). At the same time, by the interleaving of the accesses with clock-pulse timing, the integrity of the data stored in message memory 300 is ensured, and the transmission rate is also increased by utilization of the full bandwidth.

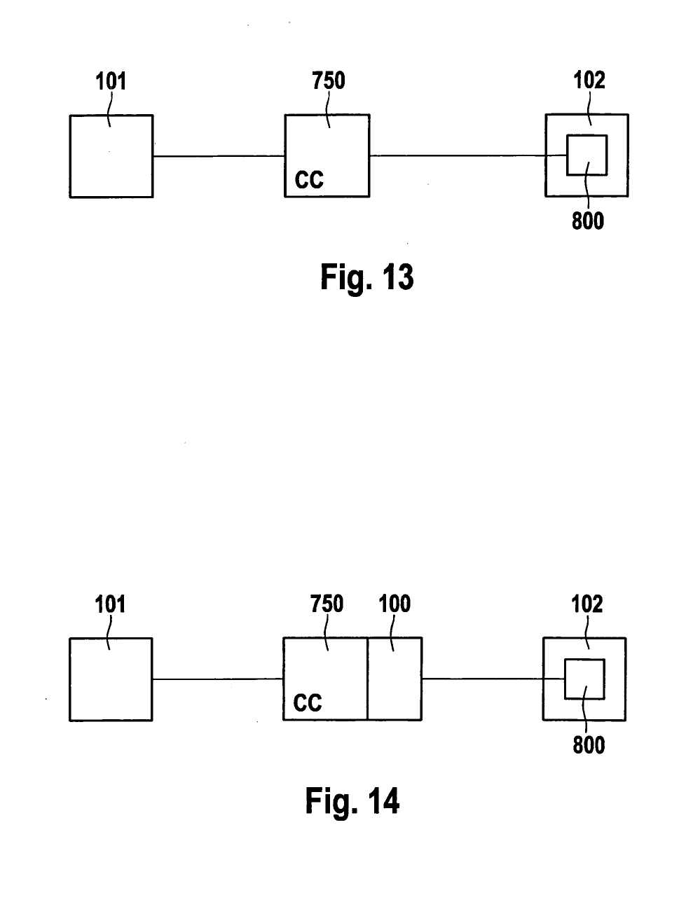

The exemplary embodiments and/or exemplary methods of the present invention relates to the connection of a microcontroller 800 of a FlexRay user 102 to a FlexRay communications control device 750 and, via such, to a FlexRay communications connection 101 in addition. FIGS. 13 and 14 illustrate various possibilities for realizing such a connection. In a connection according to FIG. 13, microcontroller 800 is connected directly to FlexRay communications controller 750. The connection is implemented via a serial interface, which may be a universal synchronous/asynchronous receiver/transmitter (USART) interface. In the connection according to FIG. 14, microcontroller 800 is indirectly connected to FlexRay communications controller 750 via a FlexRay communications module 100 such as described above with reference to the FIGS. 1 through 12. Communications module 100 may be designed as an integral part of communications controller 750 or as a separate component.

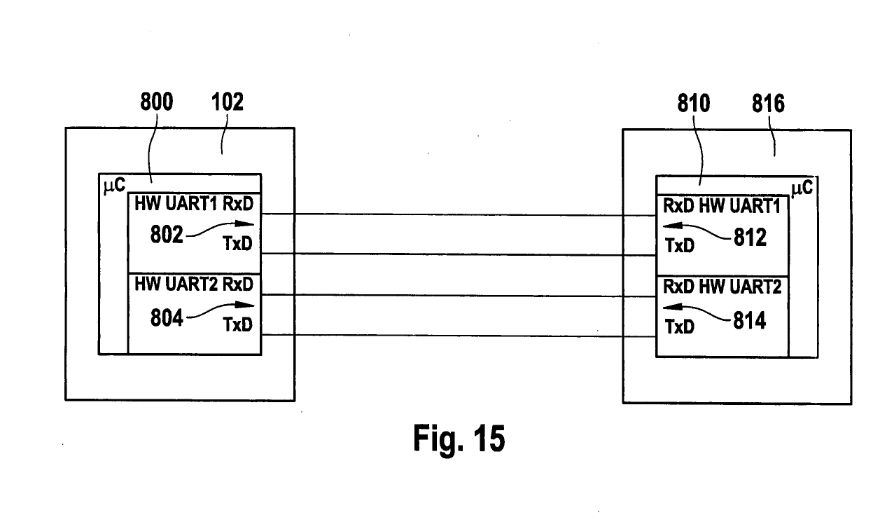

Using FIG. 15, it is illustrated that microcontroller 800 of FlexRay user 102 may be connected not only to FlexRay communications controller 750 but, via additional serial interfaces for realizing various other functionalities, to one or a plurality of additional microcontroller(s) 810. These additional functionalities are, for example, a LIN (local interconnect network) functionality or a vehicle immobilizer functionality. In the exemplary embodiment of FIG. 15, microcontroller 800 has two serial interfaces UART1 802 and UART2 804, via which it is connected to two serial interfaces UART1 812 and UART2 814. Additional microcontroller 810 is, for example, part of a motor vehicle control device 816, which controls and/or regulates the functionality of a LIN bus and a vehicle immobilizer.

It can be clearly seen in FIG. 15 that the only two serial interfaces 802, 804 of microcontroller 800 are required to realize the two functionalities of vehicle immobilizer and LIN bus. Thus, without restricting the functionality of user 102, there is no further serial interface available at microcontroller 800 for connecting user 102 to FlexRay communications controller 750. The exemplary embodiments and/or exemplary methods of the present invention is able to remedy this restriction of the functionality.

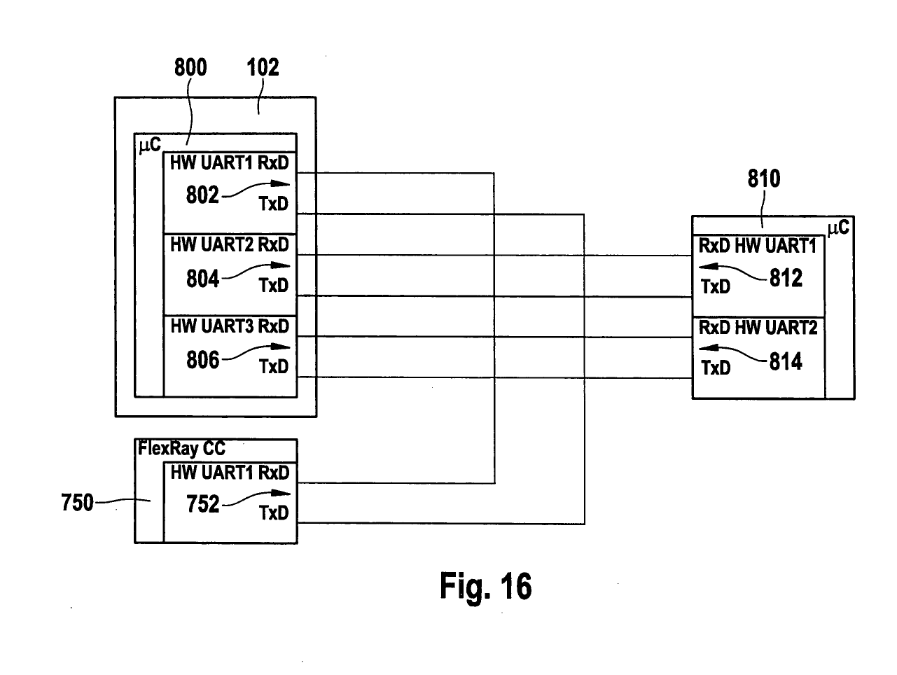

FIG. 16 illustrates a configuration according to the present invention for a connection between the two microcontrollers 800, 810 and a FlexRay communications control device 750 according to a first specific embodiment. Accordingly, an additional serial software interface 806 has been emulated in microcontroller 800. To do so, port pins, which may be port expansion pins, may be utilized, which usually are already provided in microcontroller 800 as it is. This makes it possible to realize the emulation of additional serial interface 806 at minimal expense. Since it is impossible to achieve very high data rates by the port pins, it is advantageous to use emulated serial interface 806 for the particular functionality that requires a lower data rate than the other functionality.

According to the specific embodiment from FIG. 16, microcontroller 800 is connected to FlexRay communications controller 750 via first serial hardware interface 802. To this end, controller 750 likewise includes a serial interface 752. This connection type corresponds to the connection type illustrated in FIG. 13. It is naturally conceivable, of course, to place a FlexRay communications module 100 between microcontroller 800 and communications controller 750 (cf. FIG. 14). Via second serial hardware interface 804, microcontroller 800 is connected to first serial interface 812 of the other microcontroller 810 so as to realize the particular functionality that requires a higher data rate than the other functionality, e.g., the LIN bus functionality. Via another serial interface such as the third serial interface, i.e., emulated software interface 806, microcontroller 800 is connected to second serial interface 814 of the other microcontroller 810 so as to realize the particular functionality that requires a lower data rate than the other functionality, e.g., the vehicle immobilizer functionality.

It is of course possible to supplement the existing port pins of microcontroller 800 by suitable hardware in such a way that considerably higher data rates may also be achieved via emulated software interface 806. Suitable hardware includes, for example, shift registers for buffer-storing data to be transmitted via interface 806.

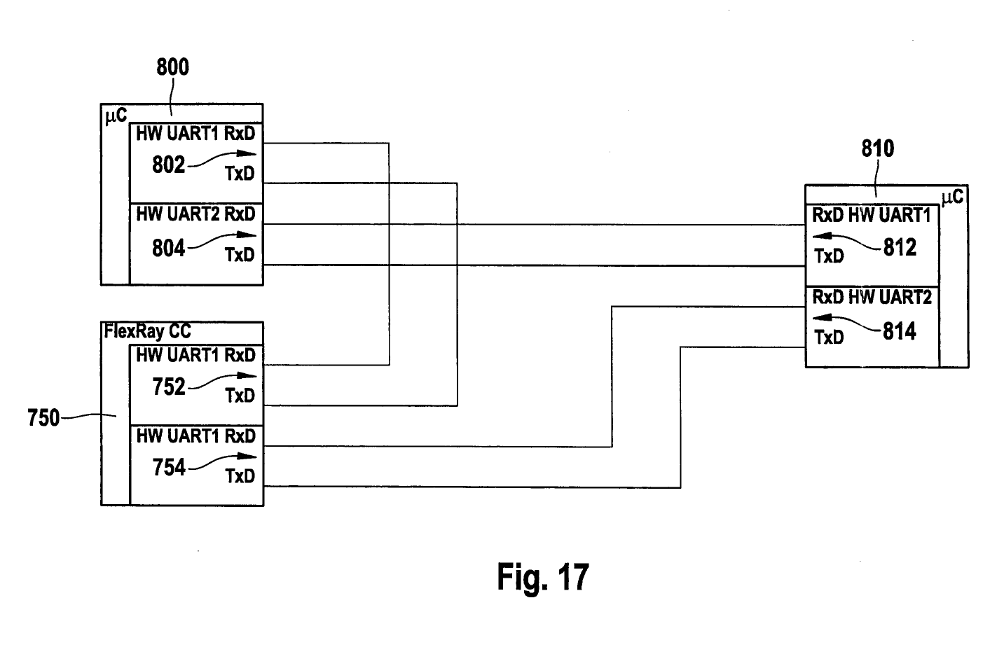

FIG. 17 illustrates a different configuration according to the present invention for a connection between the two microcontrollers 800, 810 and a FlexRay communications control device 750 according to a second specific embodiment. Microcontroller 800 remains unchanged here and, instead, an additional serial hardware interface UART2 754 is developed in communications controller 750. Additional serial interface 754 may also be realized by port expansion pins already available in FlexRay communications controller 750, as described earlier already. The port expansion pins may optionally be augmented by shift registers and/or other hardware in order to achieve a higher data rate via interface 754. Using this design, conventional microcontrollers 800 are able to be utilized for FlexRay user 102; in addition to the FlexRay functionality, the two other functionalities (such as LIN bus and vehicle immobilizer) are available as well.

A special feature of this specific embodiment is that, via the first connection between first serial interface 802 of microcontroller 800 and first serial interface 752 of communications controller 750, it is possible to realize both the FlexRay functionality and one of the two other functionalities, such as the vehicle immobilizer functionality. The FlexRay functionality is received in controller 750 by a suitable arrangement and further processed such as conditioned, and transmitted in the direction of communications link 101. The functionality received via the first connection is simply looped through communications controller 750 and routed to second serial interface 814 of other microcontroller 810 via a second serial interface 754 of controller 750 via another connection.

The other functionality, e.g., the LIN-bus functionality, is routed from the first serial interface of microcontroller 800 directly to first interface 812 of other microcontroller 810. This means therefore that in this specific embodiment, a first connection for realizing a first functionality is routed directly from a serial interface 804 to a serial interface 812 of other microcontroller 810. A second connection for realizing a second functionality is routed indirectly via FlexRay communications controller 750 from a serial interface 804 of microcontroller 800, via a first serial interface 752 into controller 750, and via a second serial interface 754 out of controller 750 again, further to a serial interface 814 of other microcontroller 810.

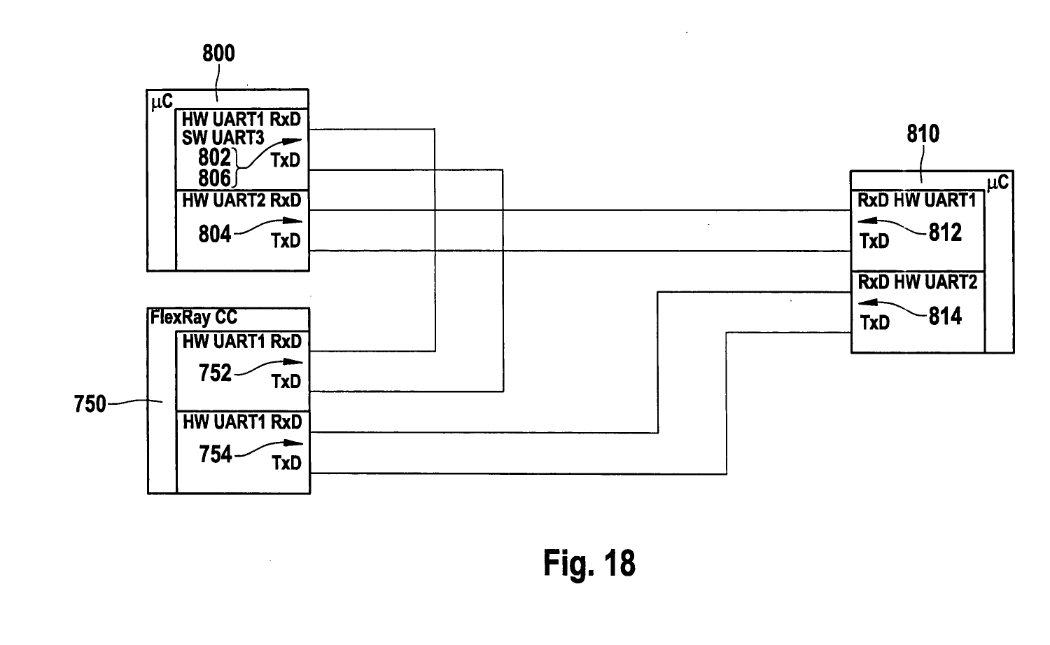

FIG. 18 illustrates another configuration according to the present invention for a connection between the two microcontrollers 800, 810 and a FlexRay communications control device 750 according to a third specific embodiment. This specific embodiment is similar to that from FIG. 17; apart from additional serial interface 754 in communications controller 750, an additional serial software interface 806 was emulated in microcontroller 800 in FIG. 18. The hardware of already provided interface 802 in microcontroller 800 was used for serial interface 806. The connections for realizing the various functionalities match those of the specific embodiment from FIG. 17.

1-12. (canceled)

13. A method for connecting a FlexRay user having a microcontroller, which includes at least one serial interface, to a FlexRay communications connection via a FlexRay communications device having at least one serial hardware interface, the method comprising:
implementing the connection between the user and the communications control device via serial interfaces; and
one of (i) emulating at least one serial interface in the FlexRay user, and (ii) developing at least one additional serial interface in the FlexRay communications control device.

14. The method of claim 13, wherein the at least one serial interface is emulated on port expansion pins provided by the communications control device as it is.

15. The method of claim 14, wherein at least one shift register in which the data to be transmitted via the interface are buffer-stored for a serial data transmission is assigned to the port expansion pins provided by the communications control device as it is.

16. The method of claim 13, wherein a first connection between one of the serial interfaces of the user and a first functionality is developed directly in at least one serial interface emulated in the user, and wherein a second connection is optionally developed directly between another one of the serial interfaces of the user and a second functionality, and an additional connection is developed directly between another one of the serial interfaces and a FlexRay functionality of the FlexRay communications device.

17. The method of claim 16, wherein the particular connection to the first or second functionality is implemented via one of the emulated serial software interfaces that requires the lower data rate.

18. The method of claim 13, wherein in at least one of the serial interfaces developed in the FlexRay communications control device, a first connection is directly developed between one of the serial interfaces of the user and a first functionality, and a second connection between one of the other serial interfaces of the user and a second functionality is looped through the FlexRay communications control device.

19. The method of claim 18, wherein the FlexRay functionality together with the second functionality is transmitted via a portion of the second connection between the user and the communications control device.

20. A FlexRay communications control device for connecting a FlexRay user, comprising:
a microcontroller, which has at least one serial interface, to a FlexRay communications link, the communications control device having at least one serial interface and the connection between the user and the communications control device being implemented via serial interfaces, wherein at least one additional serial hardware interface is developed in the FlexRay communications control device, so that the communications control device has at least one serial hardware interface.

21. The communications control device of claim 20, wherein the FlexRay communications control device includes a FlexRay communications module for coupling the FlexRay communications link to the FlexRay user, the communications module including a system for buffer-storing messages, and at least one state machine, which controls the transmission of messages between the communications link and the user so that the state machine specifies specifiable sequences regarding data for storing and transmitting the messages.

22. A FlexRay user arrangement, comprising:
at least one serial interface; and
a microcontroller having the at least one serial interface;
wherein a FlexRay user is connectable via one of the serial interfaces via a FlexRay communications control device to a FlexRay communications link, the connection between the user and the communications control device being implemented via serial interfaces, and wherein at least one serial software interface is emulated in the user, so that the user has a total of at least two serial interfaces.

23. A FlexRay communications system, comprising:
FlexRay communications control devices; and
a FlexRay communications link having FlexRay users connected thereto via the FlexRay communications control devices, at least one of the users having a microcontroller which includes at least one serial interface;
wherein the connection between the at least one user and the communications control device is implemented via serial interfaces, and wherein the at least one user is directly connected via one of its serial interfaces to a first functionality, and via another emulated serial interface is directly connected to a second functionality, and via another one of its serial interfaces is directly connected to the FlexRay functionality of a FlexRay communications control device assigned to it, or the at least one user is directly connected to a first functionality via one of its serial interfaces, and via another one of its serial interfaces it is indirectly connected to a second functionality via the FlexRay communications control device assigned to it.

24. The communications system of claim 23, wherein the FlexRay communications system has a FlexRay communications module for coupling the FlexRay communications link to at least one of the FlexRay users, and wherein the communications module includes a system for buffer-storing messages, and a state machine, which controls transmission of messages between the communications link and the user so that the state machine specifies specifiable sequences regarding data for storing and transmitting the messages.
